(19) United States
(12) Patent Application Publication
(10) Pub. No.: US 2026/0008722 A1
(43) Pub. Date: Jan. 8, 2026

(54) COATED GLASS ARTICLES

(71) Applicant: Pilkington Group Limited, Lathom (GB)

(72) Inventor: Srikanth VARANASI, Ottawa Hills, OH (US)

(73) Assignee: Pilkington Group Limited, Lathom (GB)

(21) Appl. No.: 18/875,215

(22) PCT Filed: Jun. 21, 2023
(86) PCT No.: PCT/GB2023/051619

§ 371 Date: Dec. 16, 2024

Related U.S. Application Data
(60) Provisional application No. 63/366,934, filed on Jun. 24, 2022.

(51) Int. Cl. C03C 17/34

(52) U.S. Cl. CPC C03C 17/3482; C03C 2217/211; C03C 2217/213; C03C 2218/154

(57) ABSTRACT

A coated glass article includes a glass substrate, a first coating layer based on elemental silicon deposited over the glass substrate, a second coating layer based on silicon oxide deposited over the first coating layer, and a third coating layer based on tin oxide deposited over the second coating layer. The third coating layer has a thickness of between 8 nm and 20 nm. The coated glass article exhibits a total visible light reflectance measured from the coated side (Rf) of between 40% and 50% and has a color in reflection from the coated side of an a* of from −5 to 0 and a b* of from −5 to 0.

### BACKGROUND OF THE INVENTION

The invention relates to coated glass and, in particular, to visible light reflecting coated glass articles.

Coatings on glass are commonly utilized to provide specific energy absorption and light transmittance properties. Additionally, coatings provide desired reflective or spectral properties that are aesthetically pleasing. The coated articles are often used singularly or in combination with other coated articles to form a glazing or window unit.

The attributes of the resulting coated glass substrate are dependent upon the specific coatings applied during the float glass process or an off-line sputtering process. The coating compositions and thicknesses impart light transmittance properties within the coated article while also affecting the spectral properties. Desired attributes may be obtainable by adjusting the compositions or thicknesses of the coating layer or layers. However, adjustments to enhance a specific property can adversely impact other transmittance or spectral properties of the coated glass article. Obtaining desired spectral properties is often difficult when trying to combine specific light transmittance properties in a coated glass article.

### SUMMARY OF THE INVENTION

The invention is a coated glass article that is comprised of a glass substrate, a first coating layer based on elemental silicon deposited over the glass substrate, a second coating layer based on silicon oxide deposited over the first coating layer, and a third coating layer based on tin oxide deposited over the second coating layer. The third coating layer has a thickness of between 8 nm and 20 nm. The coated glass article exhibits a total visible light reflectance measured from the coated side (Rf) of between 40% and 50% and has a color in reflection from the coated side, with an a* of from −5 to 0 and a b* of from −5 to 0.

In certain embodiments, the first coating layer has a thickness of between 8 nm and 15 nm, preferably between 10 nm and 12 nm.

In some embodiments, the first coating layer consists essentially of elemental silicon.

The first coating layer has, in certain embodiments, a refractive index of between 3 and 4, and preferably has a refractive index of between 3.2 and 3.4.

In certain embodiments, the second coating layer has a thickness of between 10 nm and 30 nm, preferably between 10 nm and 15 nm.

In some embodiments, the second coating layer consists essentially of silicon dioxide.

The second coating layer has, in some embodiments, a thickness of between 8 nm and 20 nm, preferably a thickness of between 10 nm and 15 nm.

In certain embodiments, the third coating layer has a refractive index that is greater than a refractive index of the second coating layer, and preferably has a refractive index that is between 1.9 and 2.0.

In some embodiments, the third coating layer consists essentially of SnO₂.

The coated glass article in accordance with certain embodiments of the invention has a total visible light reflectance measured from the coated side of between 42% and 48%.

In another aspect of the invention, the coated glass article has a color in reflection from the coated side of an a* of from −3 to 0 and a b* of from −3 to 0.

In certain embodiments, the glass substrate of the coated glass article is clear glass.

In some embodiments, the first, second and third coating layers are formed pyrolytically, and in certain preferred embodiments the first, second and third coating layers are formed by chemical vapor deposition.

Preferably the first coating layer is located on a first major surface of the glass substrate. The first coating layer is, in some embodiments, deposited directly on a first major surface of the glass substrate.

In some embodiments, the second coating layer is deposited directly on the first coating layer.

In some embodiments, the third coating layer is deposited directly on the second coating layer.

The third coating layer, in certain preferred embodiments, is an outermost layer and defines an outer surface of the coated glass article.

In some preferred embodiments, the first coating layer is deposited directly on a first major surface of the glass substrate, the second coating layer is deposited directly on the first coating layer, the third coating layer is deposited directly on the second coating layer, and the third coating layer is an outermost layer and defines an outer surface of the coated glass article.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is a sectional view of a coated glass article in accordance with an embodiment of the invention; and

FIG. 2 is a schematic view, in vertical section, of an installation for practicing the float glass manufacturing process in accordance with an embodiment of the invention.

### DETAILED DESCRIPTION OF THE INVENTION

It is to be understood that the invention may assume various alternative orientations and step sequences, except where expressly specified to the contrary. It is also to be understood that the specific layers, articles, methods and processes illustrated in the attached drawings, and described in the following specification are simply exemplary embodiments of the inventive concepts. Hence, specific dimensions, directions, or other physical characteristics relating to the embodiments disclosed are not to be considered as limiting, unless expressly stated otherwise.

In the context of the present invention, where a layer is said to be “based on” a particular material or materials, this means that the layer predominantly consists of the corresponding said material or materials, which means that it comprises at least about 50 at. % of said material or materials.

Unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

References herein such as “in the range x to y” are meant to include the interpretation “from x to y” and so include the values x and y.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Further, any feature set out above in relation to the first aspect of the present invention may also be utilised in relation to any other aspects of the present invention, and any invention described herein may be combined with any feature of any other invention described herein mutatis mutandis. It will also be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

In the context of the present invention the “coated side” of the glass substrate means a major surface of the glass substrate upon which the coating is located.

According to the invention there is provided a high visible light reflecting coated glass article comprising a glass substrate, a first coating layer deposited over the glass substrate, a second coating layer deposited over the first coating layer, and a third coating layer deposited over the second coating layer. The first coating layer is a reflecting layer based on silicon, the second coating layer is a layer based on silicon oxide, and the third coating layer is a layer based on tin oxide. The coating layers are such as to provide high visible light reflectance, durability, and a neutral color in reflectance when applied to a clear glass substrate.

In certain preferred embodiments, the coated glass article of the invention is utilized as a vehicle glazing, especially a side lite or back lite for a recreational vehicle.

The glass substrate 12 may be of a conventional glass composition known in the art. Preferably, the glass substrate 12 is a soda-lime-silica glass. However, the glass substrate 12 may be of another composition such as, for example, a borosilicate or an aluminosilicate composition. Additionally, the glass substrate thickness may vary between embodiments. In some embodiments, the glass substrate 12 may be tinted or colored, especially a gray tinted glass. However, it is preferred that the glass substrate 12 is substantially clear and transparent to visible light.

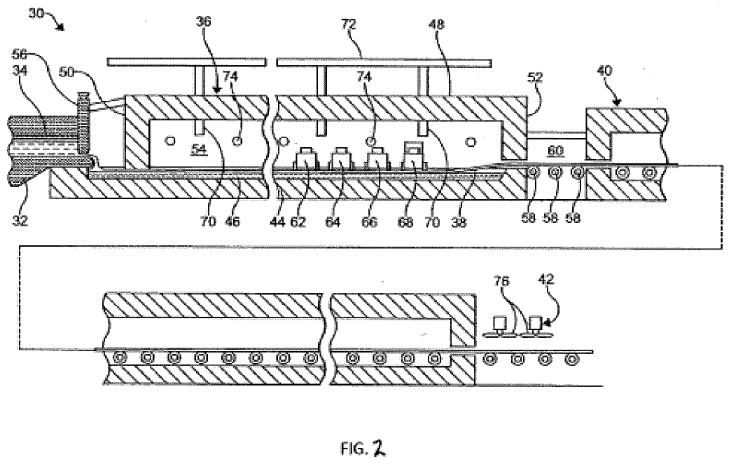

The coating layers may be applied to the glass substrate 12 in conjunction with its manufacture. In an embodiment, the glass substrate 12 may be formed utilizing the well-known float glass manufacturing process. An example of a float glass manufacturing process is illustrated in FIG. 2. In this embodiment, the glass substrate 12 may also be referred to as a glass ribbon 38. However, it should be appreciated that the method can be utilized apart from the float glass manufacturing process or well after formation and cutting of the glass ribbon.

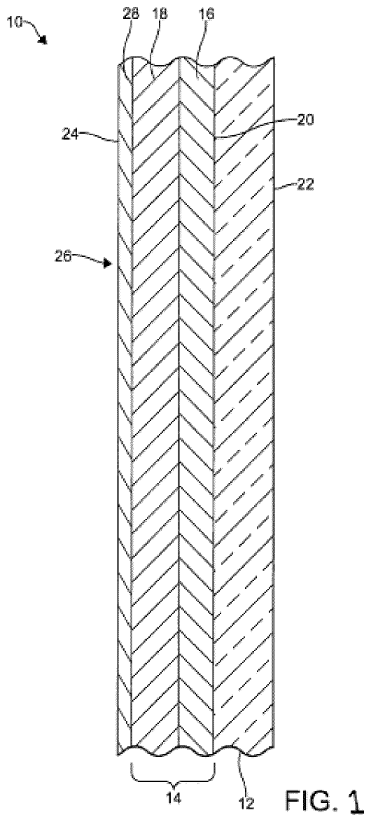

As illustrated in FIG. 1, a multi-layer coating 14 is formed over the glass substrate 12. Preferably, the coating 14 is formed directly on a first major surface 20 of the glass substrate 12. When the coating 14 is formed directly on the glass substrate 12, there are no intervening coatings between the coating 14 and the glass substrate 12. A side of the glass substrate 12 where the coating 14 is formed may be referred to herein as the coated side. A second major surface 22 of the glass substrate 12 and an opposite side of the coated glass article 10 may be uncoated.

In an embodiment, the coating 14 is pyrolytic. As used herein, the term “pyrolytic” may refer to a coating or a layer thereof that is chemically bonded to a glass substrate. Preferably, the coating 14 is formed by three or more chemical vapor deposition (CVD) processes. In certain embodiments, each CVD process is a dynamic deposition process. Thus, in these embodiments, the glass substrate 12 is moving at the time of forming the coating 14 thereon or thereover. Preferably, the glass substrate 12 moves at a predetermined rate of, for example, greater than 3.175 m/min (125 in/min) as the coating 14 is being formed. In an embodiment, the glass substrate 12 is moving at a rate of between 3.175 m/min (125 in/min) and 12.7 m/min (600 in/min) as the coating 14 is being formed.

In certain embodiments, the glass substrate 12 is heated. In embodiments where the substrate 12 is a float glass ribbon, the coating 14 is preferably applied in the heated zone of the float glass manufacturing process. In an embodiment, the temperature of the glass substrate 12 is about 1100° F. (593° C.) or more when the coating 14 is formed thereover or directly thereon. In another embodiment, the temperature of the glass substrate 12 is between about 1100° F. (593° C.) and 1400° F. (760° C.) when the coating 14 is formed.

The multi-layer coating 14 comprises the first coating layer 16, the second coating layer 18, and the third coating layer 28. In certain embodiments, the coating 14 consists of the aforementioned coating layers 16, 18, and 28. In these embodiments, there are no intervening layers between the first coating layer 16 and the second coating layer 18 or between the second coating layer 18 and the third coating layer 28.

The first coating layer 16 is deposited over and preferably directly on the first major surface 20 of the glass substrate 12. Preferably, the first coating layer 16 is deposited over the first major surface 20 of the glass substrate 12 while the surface is at essentially atmospheric pressure. In this embodiment, the first coating layer 16 is deposited by an atmospheric pressure chemical vapor deposition (APCVD) process. In certain embodiments, the first coating layer 16 is pyrolytic.

The first coating layer 16 is based on elemental silicon (Si). Preferably, the first coating layer 16 consists essentially of elemental silicon, and more preferably consists of elemental silicon. In some of these embodiments, the silicon layer may include a trace amount of one or more additional constituents such as, for example, carbon, sulfur, etc. As used herein, the phrase “trace amount” is an amount of a constituent of the silicon layer that is less than 0.01 weight %, or equivalently, less than 100 ppm. However, it is preferred that the silicon layer is essentially free of contaminants.

In order to provide a coated glass article 10 that exhibits a high visible light reflectance, it is preferred that the silicon layer 16 has a refractive index of 3.0 or more. In certain embodiments, it may be preferred that the silicon layer 16 has a refractive index of between 3 and 4, and more preferably from 3.2 to 3.4. It should be noted that the refractive index values referred to herein are for an average value across 400-780 nanometers (nm) of the electromagnetic spectrum.

The first coating layer 16 of coating 14 based on elemental silicon is deposited over the glass substrate 12 at a thickness of between 8 nm and 15 nm, preferably between 10 nm and 12 nm.

The first coating layer 16 may be deposited by forming a first gaseous mixture. In certain embodiments, the first gaseous mixture includes at least one reactant (precursor) compound suitable for forming the first coating layer at essentially atmospheric pressure. It is preferred that the at least one precursor compound suitable for use in the gaseous mixture is comprises a silane compound suitable for use in a CVD process. In an embodiment, the silane compound is monosilane (SiH₄). However, other silane compounds may be suitable for use in depositing the first coating layer 16. Such compounds may at some point be a liquid or a solid but are volatile such that they can be vaporized for use in the gaseous mixture. Once in a gaseous state, the at least one precursor compound can be included in a gaseous stream and utilized to deposit the first coating layer 16.

The first gaseous mixture may also comprise a radical scavenger. Thus, a source of a radical scavenger may also be provided for supplying the radical scavenger. In an embodiment, the radical scavenger is a hydrocarbon gas. Preferably, the hydrocarbon gas is ethylene (C₂H₄) or propylene (C₃H₆).

However, it is preferred that the first coating layer is essentially free of contaminants such as, for example, carbon. Thus, in certain embodiments, it is preferred that a radical scavenger is not provided in the first gaseous mixture. In these embodiments, the first gaseous mixture may comprise the silane compound and inert gas. In certain embodiments, the first gaseous mixture may consist essentially of the silane compound and inert gas. The inert gas may be utilized as carrier or diluent gas. Suitable inert gases for inclusion in the first gaseous mixture include nitrogen (N₂), helium (He), and mixtures thereof.

In certain embodiments, the first gaseous mixture is fed through a first coating apparatus and discharged from the first coating apparatus utilizing one or more gas distributor beams. Preferably, the first gaseous mixture is formed prior to being fed through the first coating apparatus. For example, the silane compound and inert gas may be mixed in a feed line connected to an inlet of the first coating apparatus. In other embodiments, the gaseous mixture may be formed within the first coating apparatus.

Preferably, the first coating apparatus extends transversely across the glass substrate and is provided at a predetermined distance there above. When the method is utilized in conjunction with the float glass manufacturing process, the coating apparatus is preferably provided within the float bath section thereof. However, the coating apparatus may be provided in the annealing lehr, and/or in the gap between the float bath and the annealing lehr.

The first gaseous mixture is delivered to a location above the first major surface 20 of the glass substrate 12. The first gaseous mixture is directed toward and along the glass substrate. Utilizing the first coating apparatus aids in delivering the first gaseous mixture to a location above the glass substrate 12 and directing the first gaseous mixture toward and along the glass substrate. Preferably, the first gaseous mixture is directed toward and along the glass substrate in a laminar flow. The first gaseous mixture reacts at or near the glass substrate to deposit the first coating layer thereover. Utilizing the embodiments of the first gaseous mixture described above results in the deposition of a high quality coating layer on the glass substrate. In particular, the first coating layer exhibits excellent coating thickness uniformity and can be deposited at commercially viable deposition rates.

The second coating layer 18 of coating 14 is deposited over and preferably directly on the first coating layer 16. When the second coating layer 18 is deposited directly on the first coating layer 16, there are no intervening layers between the first coating layer 16 and the second coating layer 18.

The second coating layer 18 of coating 14 is based on silicon oxide and has a refractive index that is less than the refractive index of the first coating layer 16. In certain embodiments, the refractive index of the second coating layer is 1.6 or less. In these embodiments, it is preferred that the second coating layer 18 is based on silicon dioxide (SiO₂). Silicon dioxide is a preferred material because it is dielectric and has a refractive index of about 1.46. In some embodiments, the second coating layer 18 consists essentially of silicon dioxide, and preferably the second coating layer 18 consists of silicon dioxide. Preferably, the second coating layer 18 is pyrolytic.

In certain embodiments, the second coating layer 18 is deposited over the first coating layer at a thickness of between 10 nm and 30 nm. Preferably, the thickness of the second coating layer 18 is between 10 nm and 15 nm.

The second coating layer 18 may be deposited by forming a second gaseous mixture. In certain embodiments, the second gaseous mixture includes precursor compounds suitable for forming the second coating layer 18 at essentially atmospheric pressure. It is preferred that the precursor compounds suitable for use in the second gaseous mixture are suitable for use in a CVD process. Such compounds may at some point be a liquid or a solid but are volatile such that they can be vaporized for use in the second gaseous mixture. Once in a gaseous state, the precursor compounds can be included in a gaseous stream and utilized to form the second coating layer 18.

In certain preferred embodiments, the second gaseous mixture comprises a silane compound, a radical scavenger and molecular oxygen (O₂). In an embodiment, the second gaseous mixture consists essentially of the silane compound, radical scavenger, and molecular oxygen. Further, in some embodiments, the second gaseous mixture may comprise an oxygen-containing compound. In one such embodiment, the second gaseous mixture consists essentially of the silane compound, radical scavenger, molecular oxygen, and oxygen-containing compound.

In an embodiment, the silane compound is monosilane (SiH₄). However, other silane compounds are suitable for use in depositing the second coating layer 18. For example, disilane (Si₂H₆) is a suitable silane compound for use in depositing the second coating layer 18.

The silane compound utilized in the second gaseous mixture may be pyrophoric. When molecular oxygen alone is added to the second gaseous mixture, which comprises a pyrophoric silane compound, silicon dioxide is produced. However, the silicon dioxide is produced at unacceptably high rates and an explosive reaction may result. Known methods of preventing such a reaction result in the deposition of coatings at very low, commercially impractical rates. Known methods are also limited in the amount of silane compound and oxygen which can be contained in the gaseous mixture, as too high a concentration results in gas phase reaction of the elements, and no coating layer being produced. Therefore, it is preferred that the second gaseous mixture includes the radical scavenger.

The presence of the radical scavenger allows the silane compound to be mixed with molecular oxygen and/or an oxygen-containing compound without undergoing ignition and premature reaction at the operating temperatures. The radical scavenger further provides control of and permits optimization of the kinetics of the reaction above, near, and/or on the glass substrate 12. In an embodiment, the radical scavenger is a hydrocarbon gas. Preferably, the hydrocarbon gas is ethylene (C₂H₄) or propylene (C₃H₆).

Molecular oxygen can be provided as a part of a gaseous composition such as air or in a substantially purified form. In embodiments where the second gaseous mixture comprises an oxygen-containing compound, it is preferred that the oxygen-containing compound is water (H₂O) vapor. In an embodiment, the second gaseous mixture comprises both molecular oxygen and water vapor.

The second gaseous mixture may also comprise one or more inert gases utilized as carrier or diluent gas. Suitable inert gases include nitrogen (N₂), helium (He), and mixtures thereof. Thus, sources of the one or more inert gases, from which separate supply lines may extend, may be provided.

In an embodiment, the second gaseous mixture is formed by mixing the silane compound, radical scavenger, and molecular oxygen. In some embodiments, the second gaseous mixture is formed by mixing the silane compound, radical scavenger, molecular oxygen, and oxygen-containing compound. In certain embodiments, after mixing, the second gaseous mixture is fed through a second coating apparatus and discharged from the second coating apparatus utilizing one or more gas distributor beams. Preferably, the second gaseous mixture is formed prior to being fed through the second coating apparatus. For example, the silane compound, molecular oxygen, and radical scavenger may be mixed in a feed line connected to an inlet of the second coating apparatus. In other embodiments, the second gaseous mixture may be formed within the second coating apparatus.

The second gaseous mixture is delivered to a location above the first coating layer 16. The second gaseous mixture is directed toward and along the glass substrate 12. Utilizing the second coating apparatus aids in delivering the second gaseous mixture to a location above the first coating layer 16 and directing the second gaseous mixture toward and along the glass substrate 12. Preferably, the second gaseous mixture is directed toward and along the glass substrate 12 in a laminar flow.

The second gaseous mixture reacts at or near the glass substrate 12 to form the second coating layer 18 thereover. Utilizing the embodiments of the second gaseous mixture described above results in the deposition of a high quality coating layer over the glass substrate 12 and first coating layer 16. In particular, the second coating layer 18 exhibits excellent coating thickness uniformity.

The third coating layer 28 is deposited over and preferably directly on the second coating layer 18. When the third coating layer 28 is deposited directly on the second coating layer 18, there are no intervening layers between the second coating layer 18 and the third coating layer 28. In certain preferred embodiments, the third coating layer 28 is the outermost coating layer of the coated glass article 10. In these embodiments, the third coating layer 28 may define the outer surface 24 of the coated glass article 10.

The third coating layer 28 of coating 14 is based on tin oxide and has a refractive index that is greater than the refractive index of the second coating layer 18. In certain embodiments, the refractive index of the third coating layer is between 1.9 and 2.0. In these embodiments, it is preferred that the second coating layer 18 is based on tin dioxide or SnO₂. In some embodiments, the third coating layer 28 consists essentially of SnO₂, and preferably the third coating layer 28 consists of SnO₂. Preferably, the third coating layer 28 is pyrolytic.

In certain embodiments, the third coating layer 28 is deposited over the second coating layer at a thickness of between 8 nm and 20 nm, and preferably at a thickness of between 10 nm and 15 nm. The third coating layer 28 acts as a protective layer even at these thicknesses.

The third coating layer 28 may be deposited by forming a third gaseous mixture. In certain embodiments, the third gaseous mixture includes precursor compounds suitable for forming the third coating layer 28 at essentially atmospheric pressure. It is preferred that the precursor compounds suitable for use in the second gaseous mixture are suitable for use in a CVD process. Such compounds may at some point be a liquid or a solid but are volatile such that they can be vaporized for use in the second gaseous mixture. Once in a gaseous state, the precursor compounds can be included in a gaseous stream and utilized to form the third coating layer 28.

Preferably, the third coating layer 28 tin oxide coating may be deposited by forming a gaseous mixture comprised of one or more tin compounds and one or more oxygen-containing molecules. The one or more tin compounds included in the gaseous mixture may be at least one of dimethyltin dichloride (DMT), diethyltin dichloride, dibutyltin diacetate, tetra methyl tin, methyltin trichloride, triethyltin chloride, trimethyltin chloride, ethyltin trichloride, propyltin trichloride, isopropyltin trichloride, sec-butyltin trichloride, t-butyltin trichloride, phenyltin trichloride, carbethoxyethyltin trichloride. A preferred tin compound is DMT.

The one or more oxygen-containing molecules may comprise molecular oxygen (O₂), which can be provided as a part of a gaseous composition such as air or in a substantially purified form. In another embodiment, the one or more oxygen-containing molecules may be water (H₂O) vapor, which may be provided as steam. In certain embodiments, the one or more oxygen-containing molecules may comprise two oxygen-containing molecules, such as molecular oxygen and water vapor.

In an embodiment, the third gaseous mixture is formed by mixing the one or more tin compounds and one or more oxygen-containing molecules. In certain embodiments, after mixing, the third gaseous mixture is fed through a third coating apparatus and discharged from the third coating apparatus utilizing one or more gas distributor beams. Preferably, the third gaseous mixture is formed prior to being fed through the third coating apparatus. For example, the one or more tin compounds and the one or more oxygen-containing molecules may be mixed in a feed line connected to an inlet of the third coating apparatus. In other embodiments, the third gaseous mixture may be formed within the third coating apparatus.

The third gaseous mixture is delivered to a location above the second coating layer 18. The third gaseous mixture is directed toward and along the glass substrate 12. Utilizing the third coating apparatus aids in delivering the second gaseous mixture to a location above the second coating layer 18 and directing the third gaseous mixture toward and along the glass substrate 12. Preferably, the third gaseous mixture is directed toward and along the glass substrate 12 in a laminar flow.

The third gaseous mixture reacts at or near the glass substrate 12 to form the third coating layer 28 thereover. Utilizing the embodiments of the third gaseous mixture described above results in the deposition of a high quality coating layer over the glass substrate 12, first coating layer 16, and second coating layer 18. In particular, the third coating layer 28 exhibits excellent coating thickness uniformity.

The coated glass articles 10 of the invention exhibit a total visible light reflectance measured from the coated side (Rf) of between 40% and 50%, and preferably have an Rf of between 42% and 48%. The coated glass articles 10 have a neutral color in reflection from the coated side, with an a* of from −5 to 0, preferably −5 to −2, and a b* of from −5 to 0, preferably from −3 to 0. The coated glass article will preferably pass the standard for EN1096 Class A, and thus is suitable for a first surface or exterior-facing application.

As discussed above, the multi-layer coating 14 may be formed in conjunction with the manufacture of the glass substrate 12 in the well-known float glass manufacturing process. The float glass manufacturing process is typically carried out utilizing a float glass installation such as the installation 30 depicted in the FIG. 2. However, it should be understood that the float glass installation 30 described herein is only illustrative of such installations.

As illustrated in FIG. 2, the float glass installation 30 may comprise a canal section 32 along which molten glass 34 may be delivered from a melting furnace, to a float bath section 36 where the glass substrate may be formed. In this embodiment, the glass substrate will be referred to as a glass ribbon 38. The glass ribbon 38 may be a preferable substrate on which the multi-layer coating 14 may be formed. However, it should be appreciated that the glass substrate may not be limited to being a glass ribbon.

The glass ribbon 38 advances from the bath section 36 through an adjacent annealing lehr 40 and a cooling section 42. The float bath section 36 includes: a bottom section 44 within which a bath of molten tin 46 may be contained, a roof 48, opposite side walls (not depicted) and end walls 50, 52. The roof 48, side walls and end walls 50, 52 together define an enclosure 54 in which a non-oxidizing atmosphere may be maintained to prevent oxidation of the molten tin 46.

In operation, the molten glass 34 flows along the canal 32 beneath a regulating tweel 56 and downwardly onto the surface of the tin bath 46 in controlled amounts. On the molten tin surface, the molten glass 34 spreads laterally under the influence of gravity and surface tension, as well as certain mechanical influences, and it may be advanced across the tin bath 46 to form the glass ribbon 38. The glass ribbon 38 may be removed from the bath section 36 over lift out rolls 58 and may be thereafter conveyed through the annealing lehr 40 and the cooling section 42 on aligned rolls. The deposition of the coating layers preferably takes place in the float bath section 36, although it may be possible for deposition to take place further along the glass production line, for example, in the gap 60 between the float bath 36 and the annealing lehr 40, or in the annealing lehr 40.

As illustrated in FIG. 2, a coating apparatus 62 may be shown within the float bath section 36. The first coating layer 16, second coating layer 18 and third coating layer 28 may be formed utilizing various ones of the coating apparatus 62, 64, 66 and 68.

A suitable non-oxidizing atmosphere, generally nitrogen or a mixture of nitrogen and hydrogen in which nitrogen predominates, may be maintained in the float bath section 36 to prevent oxidation of the molten tin 46 comprising the float bath. The atmosphere gas may be admitted through conduits 70 operably coupled to a distribution manifold 72. The non-oxidizing gas may be introduced at a rate sufficient to compensate for normal losses and maintain a slight positive pressure, on the order of between about 0.001 and about 0.01 atmosphere above ambient atmospheric pressure, so as to prevent infiltration of outside atmosphere. For purposes of describing the presently disclosed subject matter, the above-noted pressure range may be considered to constitute normal atmospheric pressure.

Preferably, the coating layers may be formed at essentially atmospheric pressure. Thus, the pressure of the float bath section 36, annealing lehr 40, and/or in the gap 60 between the float bath section 36 and the annealing lehr 40 may be essentially atmospheric pressure.

Heat for maintaining the desired temperature regime in the float bath section 36 and the enclosure 54 may be provided by radiant heaters 74 within the enclosure 54. The atmosphere within the lehr 40 may be typically atmospheric air, as the cooling section 42 may not enclosed and the glass ribbon 38 may be therefore open to the ambient atmosphere. The glass ribbon 38 may be subsequently allowed to cool to ambient temperature. To cool the glass ribbon 38, ambient air may be directed against the glass ribbon 38 as by fans 76 in the cooling section 42. Heaters (not depicted) may also be provided within the annealing lehr 40 for causing the temperature of the glass ribbon 38 to be gradually reduced in accordance with a predetermined regime as it may be conveyed therethrough.

### EXAMPLES

The invention is illustrated but not limited by the following Examples. In the Examples, as in the remainder of the description and claims, Tv is represents the visible light transmission measured using Illuminant C on a Perkin-Elmer Lambda 19 spectrophotometer. The Rf is the total visible light reflectance measured from the coated side, and was measured using a Colorsphere spectrophotometer available from BYK Gardner Scientific. The color of light reflected from the coated side of the coated glass articles was measured according to the CIELAB color scale coordinates of a* and b*.

Example 1 was a laboratory sample in which the coating layers were deposited on a 4″×4″ piece of clear float glass having a thickness of 3.2 mm. A first coating layer of 12 nm thick elemental silicon was deposited directly on the glass surface by chemical vapor deposition using a monosilane precursor. A 15 nm thick layer of silicon dioxide was deposited directly on the silicon layer by chemical vapor deposition using a precursor gas mixture of monosilane, ethylene, and molecular oxygen. A 12 nm thick layer of SnO₂ was deposited directly on the silicon dioxide by chemical vapor deposition using a precursor gas mixture of DMT and molecular oxygen. The thicknesses were measured using Optical Modelling. The coated glass substrate of Example 1 exhibited a Tv is of 44.2% and an Rf of 45.6%, with an a* of −3.5 and a b* of −3.0.

Table 1 provides the Rf, a*, and b* for Examples 2-18, with the layer thicknesses shown in Angstroms. Examples 2-18 are modelled by computer using software calibrated on the basis of laboratory and production coated glass articles, and the properties exhibited by each are predictive.

TABLE 1

| | Silicon(nm) | SiO₂(nm) | SnO₂(nm) | Rf | a* | b* |
|---|---|---|---|---|---|---|
| EX-2 | 10.8 | 15.0 | 12.0 | 42.8 | −3.6 | −3.8 |
| EX-3 | 11.3 | 15.0 | 12.0 | 44.0 | −3.5 | −3.5 |
| EX-4 | 11.8 | 15.0 | 12.0 | 45.1 | −3.5 | −3.2 |
| EX-5 | 12.2 | 15.0 | 12.0 | 46.1 | −3.5 | −2.9 |
| EX-6 | 12.7 | 15.0 | 12.0 | 47.1 | −3.4 | −2.6 |
| EX-7 | 13.2 | 15.0 | 12.0 | 48.1 | −3.4 | −2.2 |
| EX-8 | 12.0 | 13.8 | 12.0 | 46.0 | −3.5 | −3.5 |
| EX-9 | 12.0 | 14.7 | 12.0 | 45.7 | −3.5 | −3.1 |
| EX-10 | 12.0 | 15.0 | 12.0 | 45.6 | −3.5 | −3.0 |
| EX-11 | 12.0 | 15.3 | 12.0 | 45.5 | −3.5 | −2.9 |
| EX-12 | 12.0 | 15.6 | 12.0 | 45.4 | −3.5 | −2.8 |
| EX-13 | 12.0 | 16.2 | 12.0 | 45.2 | −3.5 | −2.6 |
| EX-14 | 12.0 | 15.0 | 10.4 | 45.9 | −3.5 | −4.0 |
| EX-15 | 12.0 | 15.0 | 11.2 | 45.8 | −3.5 | −3.6 |
| EX-16 | 12.0 | 15.0 | 12.4 | 45.5 | −3.5 | −2.8 |
| EX-17 | 12.0 | 15.0 | 13.2 | 45.3 | −3.5 | −2.2 |
| EX-18 | 12.0 | 15.0 | 13.6 | 45.2 | −3.5 | −1.9 |

Examples 1-18 demonstrate that the coated glass articles of the present invention provide high visible light reflectance and a neutral color in reflectance which is particularly desirable e.g. in some automotive applications.

In accordance with the provisions of the patent statutes, the invention has been described in what is considered to represent its preferred embodiments. However, it should be noted that the invention can be practiced otherwise than as specifically illustrated and described without departing from its spirit or scope.

1.-24. (canceled)

25. A coated glass article comprising:
a) a glass substrate;
b) a first coating layer based on elemental silicon deposited over the glass substrate;
c) a second coating layer based on silicon oxide deposited over the first coating layer; and
d) a third coating layer based on tin oxide deposited over the second coating layer, the third coating layer having a thickness of between 8 nm and 20 nm;
wherein the coated glass article exhibits a total visible light reflectance measured from the coated side Rf of between 40% and 50%, and color values in reflection from the coated side of an a* of from −5 to 0 and a b* of from −5 to 0.

26. The coated glass article of claim 25, wherein the first coating layer has a thickness of between 8 nm and 15 nm.

27. The coated glass article of claim 25, wherein the first coating layer has a thickness of between 10 nm and 12 nm.

28. The coated glass article of claim 25, wherein the first coating layer consists essentially of elemental silicon.

29. The coated glass article of claim 25, wherein the first coating layer has a refractive index of between 3 and 4.

30. The coated glass article of claim 25, wherein the first coating layer has a refractive index of between 3.2 and 3.4.

31. The coated glass article of claim 25, wherein the second coating layer has a thickness of between 10 nm and 30 nm.

32. The coated glass article of claim 25, wherein the second coating layer has a thickness of between 10 nm and 15 nm.

33. The coated glass article of claim 25, wherein the second coating layer consists essentially of silicon dioxide.

34. The coated glass article of claim 25, wherein the second coating layer has a thickness of between 8 nm and 20 nm.

35. The coated glass article of claim 25, wherein the second coating layer has a thickness of between 10 nm and 15 nm.

36. The coated glass article of claim 25, wherein the third coating layer has a refractive index that is greater than a refractive index of the second coating layer.

37. The coated glass article of claim 25, wherein the third coating layer has a refractive index that is between 1.9 and 2.0.

38. The coated glass article of claim 25, wherein the third coating layer consists essentially of SnO₂.

39. The coated glass article of claim 25 having a total visible light reflectance measured from the coated side of between 42% and 48%.

40. The coated glass article of claim 25 having a neutral color in reflection from the coated side, with an a* of from −3 to 0 and a b* of from −3 to 0.

41. The coated glass article of claim 25, wherein the glass substrate is clear glass and/or wherein the first, second and third coating layers are formed pyrolytically and/or wherein the first, second and third coating layers are formed by chemical vapor deposition.

42. The coated glass article of claim 25, wherein the first coating layer is deposited directly on a first major surface of the glass substrate and/or wherein the second coating layer is deposited directly on the first coating layer.

43. The coated glass article of claim 25, wherein the third coating layer is deposited directly on the second coating layer and/or wherein the third coating layer defines an outer surface of the coated glass article.

44. The coated glass article of claim 25 mounted as a side lite or a back lite in a vehicle.
